(19) United States
(12) Patent Application Publication
(10) Pub. No.: US 2025/0052143 A1
(43) Pub. Date: Feb. 13, 2025

(54) ANTI-DISTORTION WORKFLOW FOR BOREHOLE IMAGE RESTORATION

(71) Applicant: Halliburton Energy Services Inc., Houston, TX (US)

(72) Inventors: Brenno Caetano Troca CABELLA, Rio de Janeiro (BR); Ho Yin MA, Singapore (SG); Huiwen SHENG, Singapore (SG); Otto FANINI, Houston, TX (US); Xiang WU, Singapore (SG)

(73) Assignee: Halliburton Energy Services Inc., Houston, TX (US)

(21) Appl. No.: 18/232,608

(22) Filed: Aug. 10, 2023

(51) Int. Cl. E21B 47/002; G06T 3/40

(52) U.S. Cl. CPC E21B 47/002; G06T 3/40

(57) ABSTRACT

Systems and techniques of the present disclosure may correct sensed data to account for an offset position of an imaging tool that is deployed in a wellbore. When an imaging tool is deployed at a location that does not coincide with a center point of the wellbore, images generated from acquired data may be distorted as some of image data will be collected at locations closer to a wellbore wall than other image data. Since the resolution of a sensing device varies with distance, the resolution of data collected by a sensing device will vary with distance that separates the sensing device from the wellbore wall. Furthermore, judgments of distance to features of the wellbore wall may also be distorted because of this offset. As such, systems and techniques of the present disclosure are directed to adjust collected image data to correct for both distance and resolution related effects.

### BACKGROUND

### Technical Field

The present disclosure pertains to correcting image data collected in a wellbore. More specifically, the present disclosure is directed to removing distortions created by a sensing tool being offset from a centerline of a wellbore.

### Introduction

Generating images from data sensed in a wellbore is an important technology for various reasons. One reason for this is to identify that the wellbore meets quality and/or safety standards before that wellbore is placed into operation. In instances when a particular wellbore does not meet a quality or safety standard or has a defect that could result in a negative outcome, computer imaging may be used to generate data that may be reviewed such that actions that correct deficiencies in the wellbore may be performed.

### BRIEF DESCRIPTION OF THE DRAWINGS

In order to describe the manner in which the features and advantages of this disclosure can be obtained, a more particular description is provided with reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A is a schematic diagram of an example logging while drilling wellbore operating environment, according to some examples of the present disclosure;

FIG. 1B is a schematic diagram of an example downhole environment having tubulars, according to some examples of the present disclosure;

FIG. 2 illustrates a wellbore tool that is offset from a center line of the wellbore, according to some examples of the present disclosure;

FIG. 3 illustrates how an offset location of a wellbore tool may affect collected data, according to some examples of the present disclosure.

FIG. 4 illustrates how resolution of a wellbore imaging device may vary with the location of a wellbore imaging device, according to some examples of the present disclosure.

FIG. 5 illustrates how distorted image data can result in an interpreted location of a wellbore feature being incorrectly identified, according to some examples of the present disclosure.

FIG. 6 illustrates angles and distances that may be used to correct sets of data before images of a borehole are generated or used for a purpose, according to some examples of the present disclosure.

FIG. 7 illustrates results of applying the formula of FIG. 6 on collected data, according to some examples of the present disclosure.

FIG. 8 illustrates actions that may be performed by one or more processors that evaluate wellbore data and generate corrected images from that wellbore data, according to some examples of the present disclosure.

FIG. 9 illustrates actions that may be performed when one or more processors evaluate and correct a set of acquired data such that images may be generated from the corrected set of data, according to some examples of the present disclosure.

FIG. 10 illustrates an example computing device architecture which can be employed to perform various steps, methods, and techniques disclosed herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Described herein are systems, apparatuses, processes (also referred to as methods), and computer-readable media (collectively referred to as “systems and techniques”) for improving an accuracy of determinations made using data sensed in a wellbore. Systems and techniques of the present disclosure may correct sensed data to account for an offset position of an imaging tool that is deployed in a wellbore. When an imaging tool is deployed at a location that does not coincide with a center point of the wellbore, images generated from acquired data may be distorted as some of image data will be collected at locations closer to a wellbore wall than other image data. Since the resolution of a sensing device varies with distance, the resolution of data collected by a sensing device will vary with distance that separates the sensing device from the wellbore wall. Furthermore, judgments of distance to features of the wellbore wall may also be distorted because of this offset. As such, systems and techniques of the present disclosure are directed to adjust collected image data to correct for both distance and resolution related effects.

In this disclosure the terms “wellbore” and “borehole” may be used interchangeably as they each refer to a man-made hole into which equipment may be deployed and from which materials such as water, oil, or gas may be extracted or materials may be sequestered (e.g., carbon dioxide).

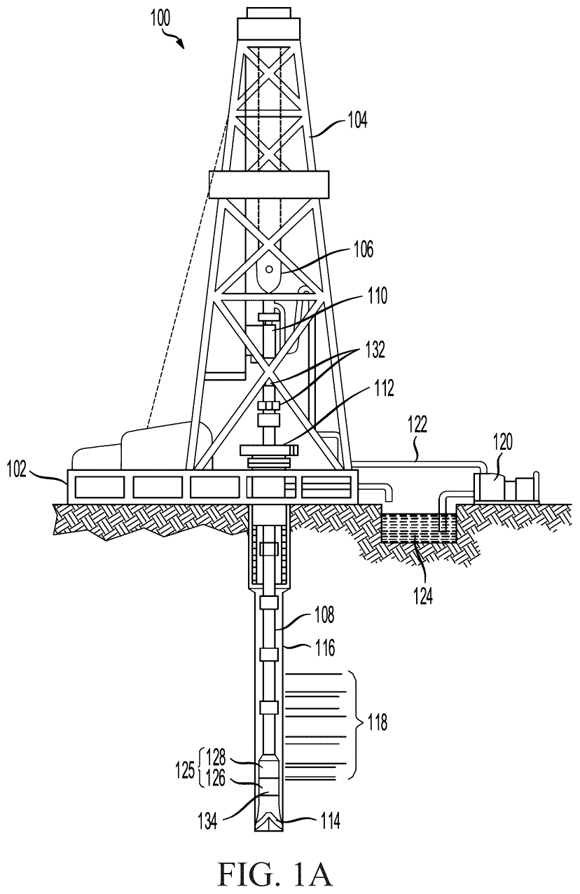

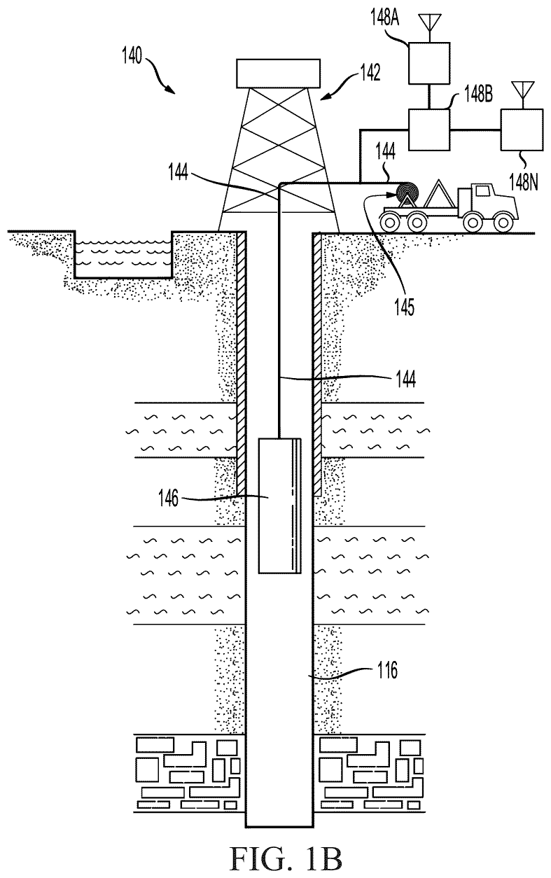

Turning now to FIG. 1A, a drilling arrangement is shown that exemplifies a Logging While Drilling (commonly abbreviated as LWD) configuration in a wellbore drilling scenario 100. Logging-While-Drilling typically incorporates sensors that acquire formation data. Specifically, the drilling arrangement shown in FIG. 1A can be used to gather formation data through an electromagnetic imager tool as part of logging the wellbore using the electromagnetic imager tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As the both drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the electromagnetic imager tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission. e.g, using mud pulse telemetry, EM telemetry, or acoustic telemetry. In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

Referring to FIG. 1B, an example system 140 is depicted for conducting downhole measurements after at least a portion of a wellbore has been drilled and the drill string removed from the well. An electromagnetic imager tool can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the electromagnetic imager tools described herein.

The illustrated wireline conveyance 144 provides power and support for the tool, as well as enabling communication between data processors 148A-N on the surface. In some examples, wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via wireline conveyance 144 to meet power requirements of the tool. For slickline or coiled tubing configurations, power can be supplied downhole with a battery or via a downhole generator.

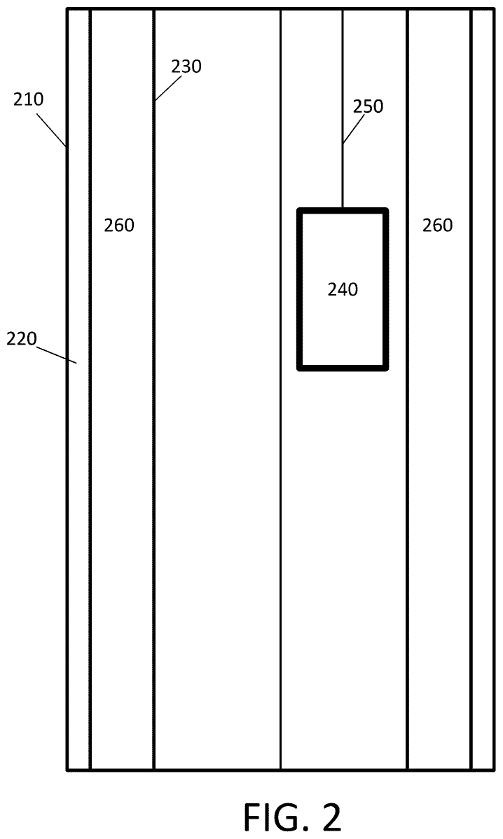

FIG. 2 illustrates a wellbore tool that is offset from a center line of the wellbore. FIG. 2 includes wellbore 210, casing 220, tubing 230, and wellbore tool 240 that is deployed next to tubing 230 inside of casing 220 with deployment string 250. In certain instances, casing 220 may be cemented in place into wellbore 210 such that one or more sets of tubing, like tubing 230, and wellbore tools, like wellbore tool 240 can be deployed into the wellbore in space 260. Space 260 is an area within an inner portion of casing 220. Tubing 230 may be deployed within casing 230 such that one or more wellbore operations can be implemented. Tubing 230 may be deployed in instances when wellbore 210 will be used to extract oil or gas from a subterranean formation or when carbon dioxide is sequestered into the Earth next to wellbore 220. While one casing and one set of tubing are illustrated in FIG. 2, systems and techniques of the present disclosure may be used in wellbores that include more than one casing and/or more than one set of tubing. This may mean that an imaging device may be located near multiple steel pipes (e.g., a steel casing and multiple steel tubes).

Wellbore tool 240 may include imaging equipment that is used to collect data regarding formations that surround casing 220. Wellbore tool 240 and tubing 230 are both deployed in casing 220 of wellbore 210 at locations that are offset from a center line of both casing 220 and wellbore 210. When wellbore tool 240 collects image data of structures and materials located near wellbore 210, the collected image data will not be symmetrical because of the offset position of wellbore tool 240. This lack of symmetry will affect sensed data and may make images generated from that sensed data be inaccurate as compared to images generated when symmetrical data is used to generate images.

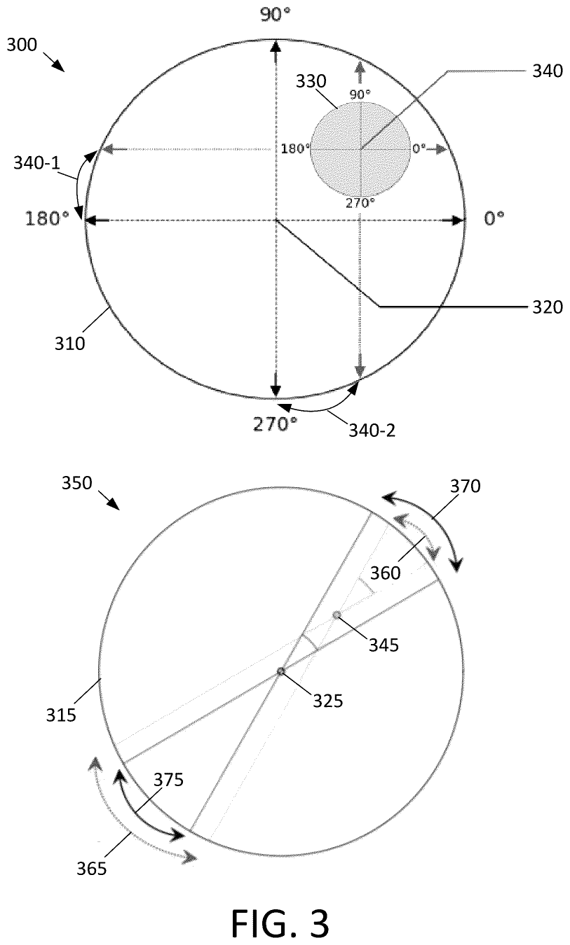

FIG. 3 illustrates how an offset location of a wellbore tool may affect collected data. Illustration 300 of FIG. 3 is a cross-sectional view of a wellbore that may have been generated by one or more processors executing instructions that model a wellbore reference system. This cross-sectional view is from a perspective that is perpendicular to sidewalls of the wellbore 310, as such this cross-sectional view part of an imaginary cross-sectional plane of a wellbore. Point 320 may be a center point of wellbore 310 that was identified by the processors that model the wellbore reference system. Point 340 may be a center point of a tool 330 that was identified by one or more processors executing instructions that model a tool reference system. Note that center point 340 is offset from center point 320. This offset indicates that the wellbore tool 330 is not located in the center 320 of wellbore 310.

Processors executing instructions that model the wellbore reference system and the wellbore tool reference system may represent locations as circles with degrees of orientation relative to a plane that cuts through a cross-section of wellbore 310. Since the cross-sectional representation of the wellbore spans 360 degrees, images associated with the wellbore reference system and the tool reference system both include orientations of zero (0) degrees through 360 degrees. Each of these reference system illustrations specifically identify orientations of 0 degrees, 90 degrees, 180 degrees, and 270 degrees. Illustration 300 shows that wellbore tool 330 is located above and to the right of center point 320 of wellbore 310. Arcs 340-1 and 340-2 show an offset angle associated with differences between center point 320 of wellbore 310 and center point 340 of wellbore tool 330. Offsets associated with arcs 340-1 and 340-2 result in eccentricities being introduced into sets of collected data. These eccentricities may be caused by offsets in an azimuthal direction and by variations in sensing resolution that are caused by these azimuthal offsets. Eccentricities caused by offsets in a direction may be related to the inconsistencies or differences between the tool reference system and wellbore reference systems' azimuth positions.

Note that the “zero” of the tool reference system is not the “zero” of the wellbore reference system. Distortions associated with these eccentricities may occur along all azimuths in a non-linear fashion. Illustration 350 of FIG. 3 shows how differences in distance between the wellbore imaging device and the wall of the wellbore affect resolution. When the wellbore imaging device is closer to the wall of the wellbore, resolution increases and when the wellbore imaging device is farther from the wall of the wellbore, resolution decreases. In instances when the azimuthal resolution of the tool is fixed, azimuthal resolution will change with relative distance between the tool and the wellbore wall. When sensing elements of a wellbore tool (e.g., a wellbore imaging device) collect data, this changing distance between the wellbore tool and the wellbore wall will result in data being collected that does not accurately represent features located along a wellbore.

Illustration 350 includes wellbore 315, point 325, point 345, and a set of arcs (360, 365, 370, and 375). In operation, an imaging device may have an aperture that provides a viewing angle where fields of view increase with distance from a center point of the imaging device. While located within wellbore 315, this imaging device may rotate as sensors of the imaging device collect data. When the imaging device is located at a position that does not correspond to the center of the wellbore (e.g., at point 345), data acquired by the imaging device in some orientations will have a greater resolution (as indicated by arc 360) than data acquired in other orientations (as indicated by arc 365). This means that images generated from acquired data without adjusting for the changing resolution will be inaccurate.

When collecting data, the imaging device may emit pulses of energy (e.g., acoustic, electromagnetic, or other) and sensors of the imaging device may receive reflections of that emitted energy such that images may be made from sensed data. In certain instances, an imaging device may receive energy from energy emitters that are located elsewhere. For example, the imaging device may receive energy that was transmitted by transmitters located at the surface of the Earth or in another wellbore. In any of these instances, images generated from uncompensated sensor data will be distorted.

As shown in illustration 350, when the wellbore tool is located at point 325 (a point that coincides with the center point of wellbore 315), fields of view for the given aperture at the wall of wellbore 315 correspond to lengths of arcs 370 and 375. Since at this time the wellbore tool is located at center point of wellbore 315, the fields of view indicated by arcs 370, and 375 are equal because distances from center point 325 to the wall of wellbore 315 are the same at each radial position. In such an instance, data acquired by the imaging device will be relatively symmetrical and have minimum eccentricity. When the imaging device is located at offset position (e.g., at point 345), distance between the imaging device and the wall of wellbore 310 vary as the imaging tool rotates. This means that the distance separating the sensing elements of the imaging device will change as the imaging device rotates. The field of view of the imaging device relative to the wall of wellbore 310 will change, as shown by arcs 360 and 365, when the imaging device is located at offset position, point 345. As such, data collected using an imaging tool will be distorted unless the sensed data is corrected for offsets that vary with locations of the wellbore tool.

When the distance to the wall of a wellbore varies based on the wellbore tool being located at an offset position, resolution of images generated using uncompensated data will vary with radial position or degrees of rotation. This effect will affect the field of view of the wellbore imaging tool. When the wellbore imaging tool rotates at such an offset location, data sensed (or otherwise collected) by the wellbore imaging tool may result in distorted (or “myopic”) images of structures near to wellbore being generated. Such distorted images can make determinations based on these images be inappropriate for a given condition of a wellbore. For example, when a casing is not securely cemented to the walls of a wellbore, the casing may be exposed to water, hydrocarbons, and/or other substances that may cause the casing to deteriorate (e.g., rust) at an unacceptable rate because of a void in the cement. Such a void may be an absence of cement that forms a channel that may allow fluids to flow to the casing. Actions that may be used to fill such a void may be based on the size and location of the void. In such an instance, an inappropriate determination may result in too little or too much cement being supplied, or cement may be provided to an incorrect location. While voids and cement defects are discussed, data collected may be used to identify other types of features that may be encountered in a wellbore. For example, rusted/deteriorated or cracked portions of a casing may be identified, types of rocks or materials included in a subterranean formation may be identified, fluids may next to a casing may be identified, materials located in an uncased wellbore may be identified, other type of casing defect, or anomalies associated with the wellbore may be identified.

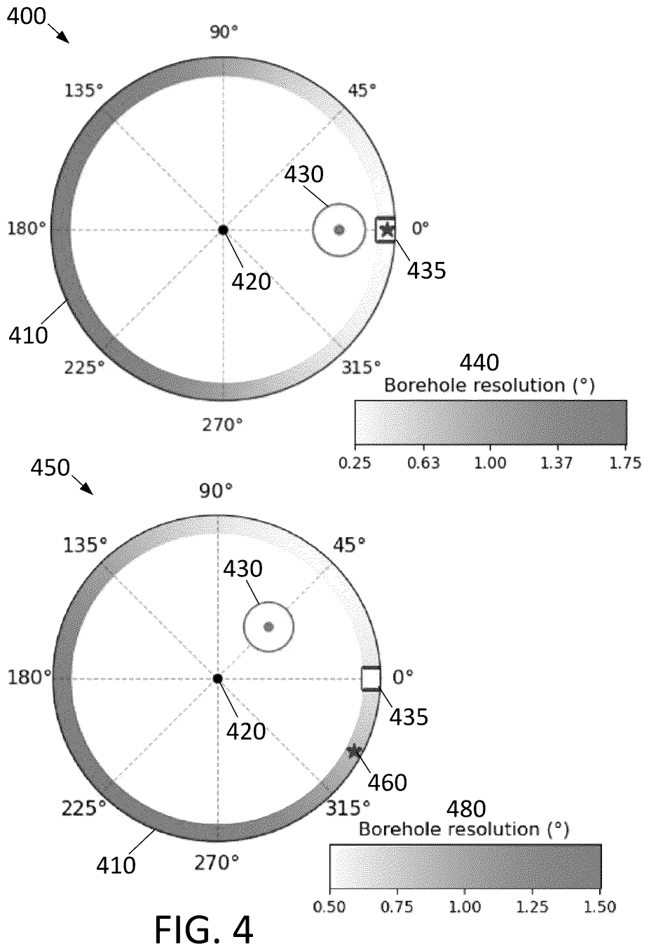

FIG. 4 illustrates how resolution of a wellbore imaging device may vary with the location of the wellbore imaging device. FIG. 4 also illustrates how distorted image data can result in an interpreted location of a feature of a wellbore changing with the location of the wellbore imaging device. FIG. 4 includes illustration 400 and illustration 450 that show how an interpreted position ★ of a wellbore feature (e.g., a void or channel) may change when position of a wellbore imaging device 430 is changed relative to the center point 420 of wellbore 410.

Illustration 400 also includes borehole (wellbore) resolution scale 440. This scale 440 shows resolution of wellbore imaging device 430 changing from 0.25 degrees to 1.75 degrees as radial position of wellbore 410 changes from 0 degrees to 180 degrees. These degrees of resolution also change from 1.75 degrees to 0.25 degrees as the radial position of wellbore 410 changes from 180 degrees to 360 degrees.

Note that imaging device 430 in illustration 400 is closer to the right side of wellbore 410 and is positioned on a line that connects center point 420 with radial position 435 (0 degrees). The star shaped indicator ★ of illustration 400 identifies an interpreted position of a wellbore feature, where the white square 435 in illustration 400 shows the actual location of the wellbore feature. In this instance, the interpreted feature location ★ corresponds to the actual feature location 435 of the feature because of how imaging device 430 and acutal feature location 435 are aligned. Even though a correct feature location may be identified, the size of this feature may be distorted based on the position of imaging device 430.

Illustration 450 includes borehole (wellbore) resolution scale 480 of wellbore 410. While being similar to the scale 440 of illustration 400, scale 480 includes different measures of resolution because wellbore imaging tool is located at different positions in each of illustrations 400 and 450. Imaging device 430 in illustration 450 is offset the right side of wellbore 410 and is positioned on a line that connects center point 420 with a radial position of 45 degrees. The interpreted position ★ of feature 435 in illustration 450 is located at incorrect position 460 (at a radial position of about 325 degrees). In such an instance, the interpreted feature position ★ does not correspond to the actual feature location 435 because of location related distortion effects.

The borehole (wellbore) resolution 480 of illustration 450 corresponds to degrees of resolution that vary from 0.50 degrees to 1.50 degrees as radial position of wellbore 410 changes from 45 degrees to 225 degrees. Illustration 450 also shows that these degrees of resolution also vary from 1.75 degrees to 0.25 degrees as the radial position of wellbore 410 changes from 225 degrees to 45 degrees.

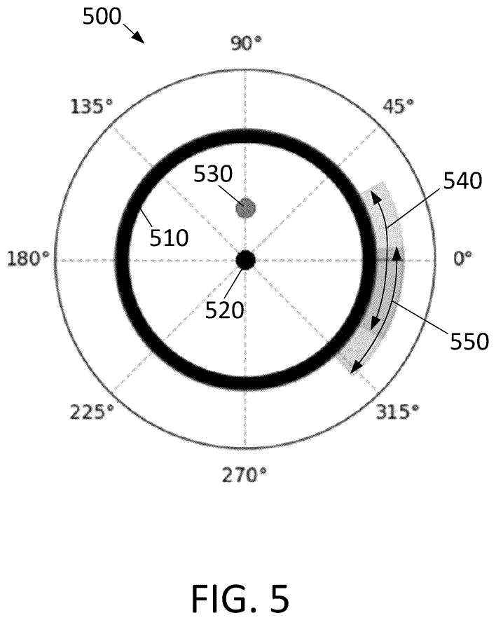

FIG. 5 illustrates how distorted image data can result in an interpreted location of a wellbore feature being incorrectly identified. Illustration 500 shows casing 510 located within a wellbore. The center of casing 520 is identified by point 520. Illustration 500 shows radial positions that change from 0 degrees to 360 degrees relative to center point 520. Illustration 500 also shows that imaging device is located above center point 520 at point 530 that is on the 90 degree radial position of illustration 500. Illustration 500 also shows that the location and possibly the size of an anomaly outside of casing 510 may be imaged incorrectly based on the sensing device being located at point 530 that is offset from wellbore center point 520. The location and size of the actual anomaly corresponds to arc 540 where an erroneous interpreted location and size of the anomaly corresponds to arc 550.

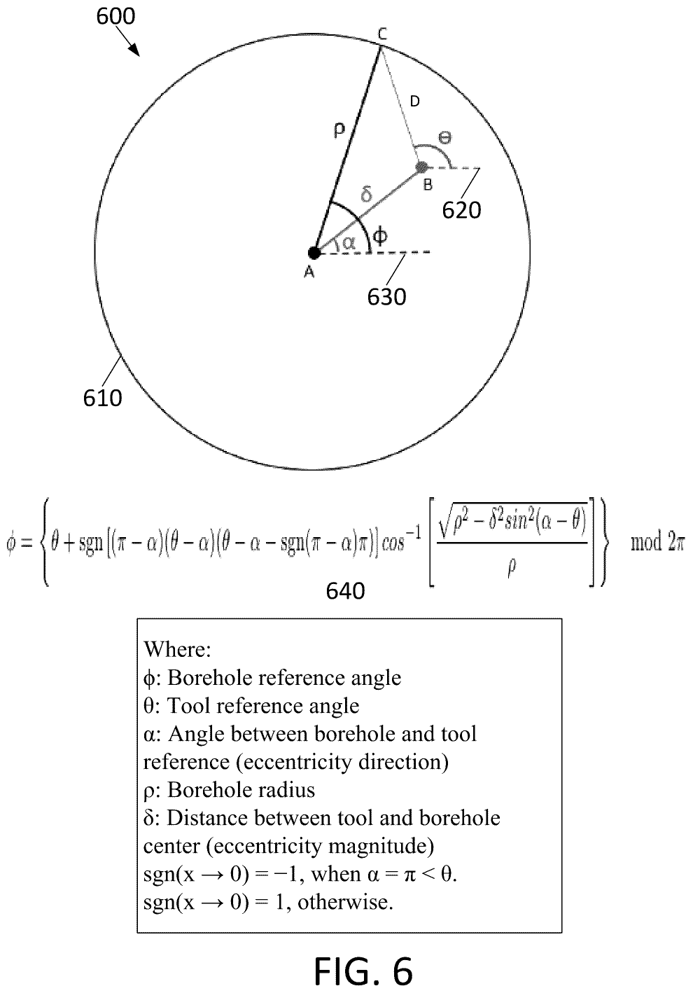

FIG. 6 illustrates angles and distances that may be used to correct sets of data before images of a borehole are generated or used for a purpose. FIG. 6 includes points A, B, and C, where point A identifies a center of borehole 610, point B identifies a location of a borehole tool (a tool reference point), and point C is an edge point of borehole 610. Points A, B, and C may be associated with each other via a geometric construction that associates borehole center point A with the tool reference point B and with borehole edge point C.

Points A, B, and C all lie along a cross-sectional plane of borehole 610. Illustration 600 also includes various factors that may be associated with each other. These various factors include borehole reference angle ϕ, tool reference angle θ, eccentricity angle α, borehole radial line ρ, and eccentricity magnitude line δ. Illustration 600 also includes lines 620 and 630, where line 620 lies on a first imaginary reference plane and line 630 lies on a second imaginary reference plane. This first reference plane and the second reference plane are both perpendicular to the cross-sectional plane of borehole 610. Line 620 is located at the intersection of the first reference plane and the cross-sectional plane of borehole 610, and line 630 is located at the intersection of the second reference plane and the cross-sectional plane of borehole 610. Line 620 may be referred to as a first line and line 630 may be referred to as a second line of FIG. 6.

Tool reference angle θ may be identified by rotating reference line 620 along the cross-sectional plane until it intersects borehole edge point C, as shown by the angle between line D and line 620. Line D may be referred to as a third line of FIG. 6 that may have a length that corresponds to a distance between the tool reference point B and the borehole edge point C. Eccentricity angle α may be identified by rotating reference line 630 to overlap with eccentricity magnitude line δ, and borehole reference angle ϕ corresponds to a rotation of reference line 630 until it overlaps with borehole radial line ρ. Values of angles ϕ, θ, and a as well as lengths of lines ρ and δ are related to each other according to formula 640 of FIG. 6. Eccentricity angle α is an angle between borehole center point A and tool reference point B in an eccentricity direction, the length of line ρ is equal to the radius of borehole 610, and the length of line δ corresponds to a distance that separates borehole center point A from tool reference point B. The length of line δ may correspond to a magnitude of eccentricity and line δ may be referred to as a fourth line of FIG. 6.

As such, ϕ is a borehole reference angle; θ is a tool reference angle, a is an angle between borehole center point A and tool reference point B in an eccentricity direction; ρ: is a radius of the borehole; and δ is a distance (or eccentricity magnitude) between the borehole tool reference point B and center point A of the borehole, where the function sgn (x→0)=−1, when α=π<θ; otherwise the function sgn (x→0)=1.

One or more of the factors of formula 640 may be known when a tool is deployed in a borehole, for example, an initial radius of the borehole may be known. Even when the borehole radius remains constant, other factors of formula 640 will change when the borehole tool operates. When sensing elements of the borehole tool rotate, each respective image may be associated with a different borehole edge point and this will result in many of the other factors changing with that rotation. This means that collected data will have to be corrected for eccentricity according to formula 640 at least for each different edge point location associated with a set of acquired data.

When the borehole tool rotates, that tool may acquire data as a series of snapshots. Each snapshot may correspond to a particular time and radial position of a tool reference system, where each radial position may correspond to a different edge point of the borehole. Each snapshot may be assigned a timestamp and collected data may include an identified radial position of the tool reference system and a timestamp. As such, data of each respective snapshot may be cross-referenced to a time and angle. Based on this information, one or more processors executing instructions of an anti-distortion restoration function may perform calculations consistent with formula 640 of FIG. 6 when collected data is corrected. As such, the one or more processors may execute instructions as part of a workflow that corrects eccentricities by identifying the tool reference angle θ, the angle α between a wellbore center point and a tool reference point in an eccentricity direction (eccentricity angle), the wellbore radius ρ and the distance between the wellbore tool and the wellbore center point (eccentricity magnitude) δ, and by calculating the wellbore (borehole) reference angle ϕ.

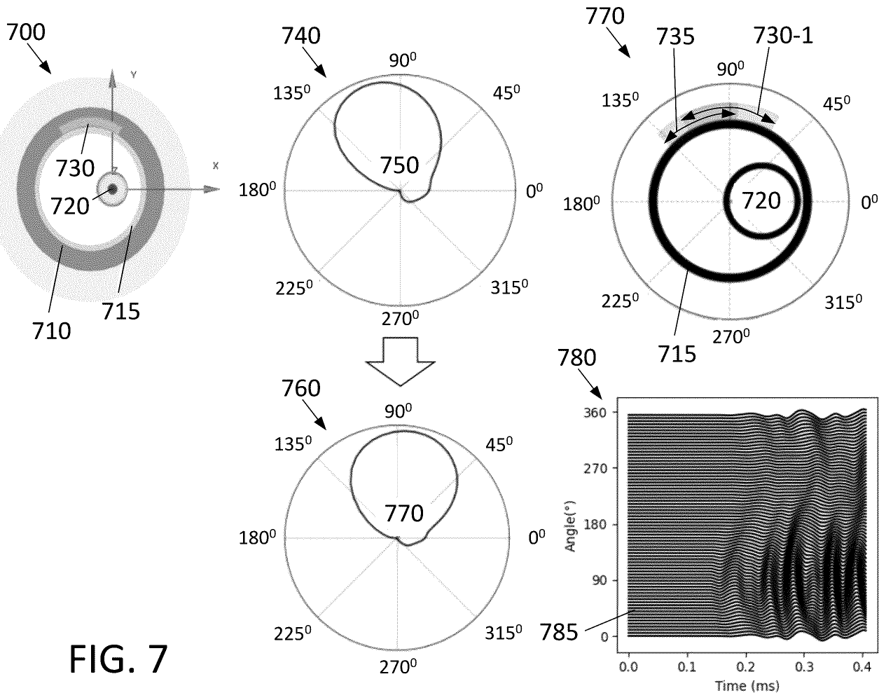

FIG. 7 illustrates results of applying the formula of FIG. 6 on collected data. Illustration 700 shows tool 720 located in casing 715 of wellbore 710 at an off-center location and shows the actual location and size of a feature 730 next to wellbore 710. Here again feature 730 may be a void or channel located next to a casing 715 cemented into wellbore 710. Differences between illustration 740 and illustration 760 graphically show how eccentricities associated with the off-center location depicted in illustration 700 may be corrected by applying formula 640 of FIG. 6 using collected data. Illustration 770 shows how images generated using uncorrected data may misrepresent the actual location and possibly size of wellbore feature 730 of illustration 700. Illustrations 740, 760, and 770 each include a scale of degrees that may be associated with a wellbore reference system or a computer model used to evaluate and correct sensed data.

When tool 720 collects sensor data or when a simulation is run using acquired data, the offset position of tool 720 may result in eccentricities that distort images generated from the collected sensor data, such eccentricities are illustrated by differences in shapes of plot 750 of illustration 740 and plot 770 of illustration 760. Plots 750 and 770 may correspond to root means squared (RMS) values of a sensed signal. When acoustic imaging is used, a higher RMS value of acoustic signal will tend to correspond to an area of the wellbore where a casing is not firmly adhered to structures of the wellbore. This is because acoustic energy will not be efficiently coupled to rocks of a wellbore when the casing is not properly cemented to the wellbore rocks. In such an instance, the casing may “ring” like a bell. In contrast, acoustic energy emitted into a casing that is cemented properly will transfer the acoustic energy into the wellbore rocks where it rapidly dissipates.

Since data used to generated plot 750 of illustration 740 is affected by the offset position of tool 720 in casing 715, images of wellbore features using this data will have eccentricities. While plot 750 identifies an apparent channel in cement at a location of wellbore 710, it inaccurately identifies the location where the channel is located. Since plot 770 is made from corrected data, it more accurately identifies the location of the channel.

Illustration 770, like illustration 500 of FIG. 5 shows radial positions of a feature or an anomaly (e.g., a void or channel) next to casing 715. Here again, when uncorrected data is used, a location or size of the anomaly may be incorrectly identified. An incorrect position and size of wellbore feature 730 is shown by arc 735 and a corrected position and size of wellbore feature 730 is shown by arc 730-1 of illustration 770. Illustration 780 of FIG. 7 shows image 785 that may have been generated from acoustic data collected in a wellbore or from a simulation that models acoustic data. Illustration 780 includes a horizontal axis of time and a vertical axis of angle that ranges from 0 degrees to 360 degrees. Image 785 plots for different azimuth angles, RMS values of signal sensed by a sensor. As mentioned above, a location with relatively higher RMS signal values is more likely indicative of the presence of a void or channel in wellbore cement than areas that have lower RMS signal values. In the left portion of image 785 that spans from 0 seconds to about 0.15 milliseconds of the time axis of illustration 780, there are little to no variations in RMS signal values. At time greater than about 0.15 milliseconds, increases in RMS values correspond to areas that include wave like variations in image 785. This means that the areas where the wave like variations appear may likely be caused by the presence of a void or channel in cement that attaches casing 715 to wellbore 710.

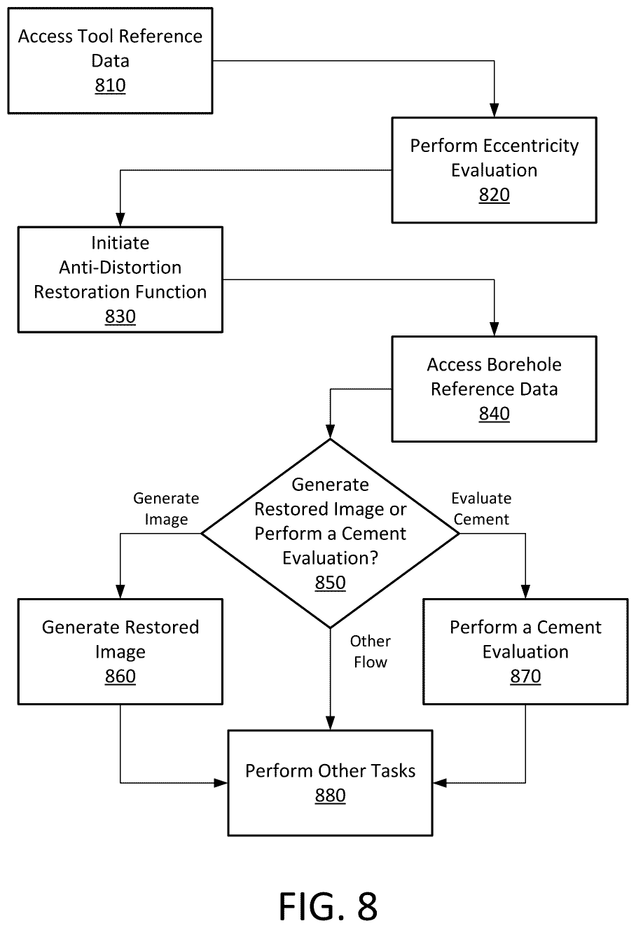

FIG. 8 illustrates actions that may be performed by one or more processors that evaluate wellbore data and generate corrected images from that wellbore data. At block 810, a set of tool reference data may be accessed. This reference data may include acquired data and may possibly include information regarding the location where a wellbore tool is deployed relative to a center point of the wellbore, a radius of the wellbore, and/or other information. At block 820 an eccentricity evaluation may be performed to identify a direction and magnitude of eccentricity to attribute to the wellbore tool. This evaluation may estimate eccentricity by measuring a third echo interface (TIE) response, where data obtained may be obtained using advanced ultrasonic and flexural measurements that may measure an azimuthal radius and thickness of an innermost portion of a casing from which an azimuthal annular distance associated with the casing may be identified, for example, based on a flexural wave TIE arrival time and the velocity of that wave in an annular fluid.

At block 830 an anti-distortion function may be initiated on an acquired set of data. This anti-distortion function may be used to correct for eccentricities by identifying tool reference angle θ, the angle between a borehole (i.e., wellbore) center point and a tool reference point in an eccentricity direction a, the borehole radius ρ, and the distance between the borehole tool and the borehole center point (eccentricity magnitude) δ. Calculations may be performed to identify the borehole reference angle ϕ according to formula 640 of FIG. 6. At block 840 borehole reference data may be accessed. Distortion effects that may affect a distance to a wellbore feature or variations in resolution that distort acquired data may be compensated for by interpolating between data samples and generated data at an adjusted sample rate based on the between sample interpolations when a resampling function is performed. By correcting for the effects of variations in distance and resolution, data collected by the tool in the offset position may be corrected to correspond to reference angles ϕ relative to the center point of the borehole.

Depending on a particular circumstance, corrected data may be applied to a task of interest. For example: corrected data may be provided to a processor that generates images, corrected data may be provided to a processor that performs cement quality evaluations, or corrected data may be provided to processors when other tasks are performed. Block 850 of FIG. 8 represents that corrected data may be provided to any process of a workflow. When a workflow is directed to generating images—images may be generated at block 860, when the workflow is directed to cement evaluations—cement evaluations may be performed at block 870, when the workflow is directed to other tasks—other tasks may be performed at block 880.

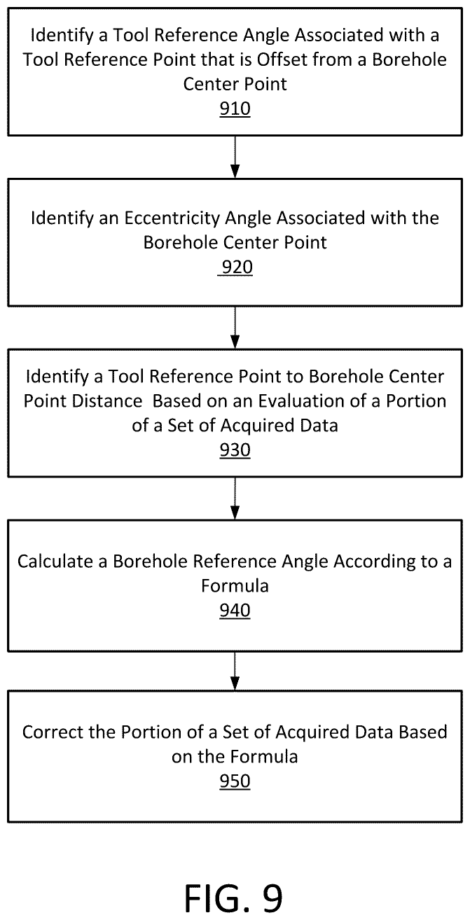

FIG. 9 illustrates actions that may be performed when one or more processors evaluate and correct a set of acquired data such that images may be generated from the corrected set of data. The actions performed in FIG. 9 may result in calculations being performed according to formula 640 of FIG. 6. These calculations may include actions consistent with the anti-distortion restoration function discussed in respect to FIG. 8. At block 910 a tool reference angle θ associated with a tool reference point B that is offset from a borehole center point A may be identified. As discussed in respect to FIG. 6, the tool reference angle θ may correspond to a rotation of a first line 620 from a first reference plane to a borehole reference point C of FIG. 6. One or more processors may execute instructions to perform calculations using values of radius ρ and eccentricity magnitude δ to identify tool reference angle θ. Here, the value of radius ρ may be known, and tool reference angle θ may be determined based on a position of edge point C and location of tool reference point B.

At block 920 an eccentricity angle α associated with the borehole center point A may be identified. As discussed in respect to FIG. 6, this eccentricity angle α may correspond to a rotation of a second line 630 from a second reference plane to the tool reference point B and the eccentricity angle α may be identified based on the second reference plane being parallel to the first reference plane. At block 930 an eccentricity magnitude δ (a distance separating tool reference point B and borehole center point A) may be identified based on an evaluation of a portion of a set of acquired data.

At block 940 a borehole reference angle ϕ may be identified based on a formula 640 that associates the borehole reference angle ϕ with values of: tool reference angle θ, eccentricity angle α, borehole radius ρ, and eccentricity magnitude δ (the distance separating tool reference point B and the borehole center point A). At block 950 the portion of the set of acquired data may be corrected based on the formula 640 of FIG. 6 that associates the borehole reference angle ϕ with the values of: tool reference angle θ, eccentricity angle α, borehole radius ρ, and eccentricity magnitude δ (the distance separating the tool reference point B and the borehole center point A).

Once data is corrected, it may be applied to any process associated with determining that structures of a wellbore correspond to a set of requirements, may help maintain operation of a wellbore by demonstrating that conditions of the wellbore still correspond to the set of requirements, and/or may be used to identify a action that may be used to correct issues or defects associated with the wellbore. As such, systems and techniques of the present disclosure may assist in developing and maintaining a wellbore according to the set of requirements.

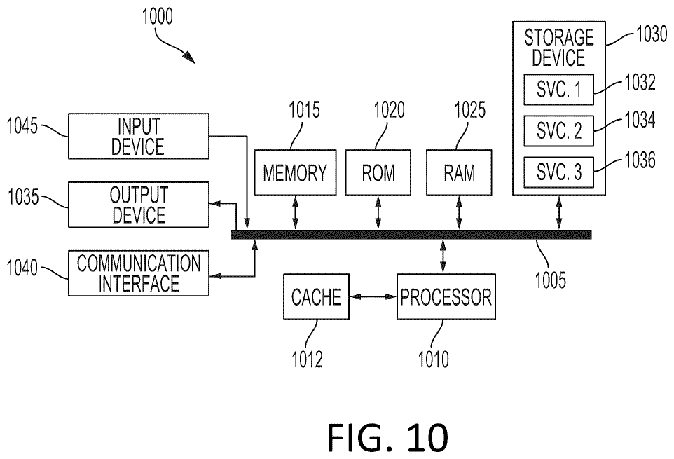

FIG. 10 illustrates an example computing device architecture 1000 which can be employed to perform various steps, methods, and techniques disclosed herein. Specifically, the computing device architecture can be integrated with the electromagnetic imager tools described herein. Further, the computing device can be configured to implement the techniques of controlling borehole image blending through machine learning described herein.

As noted above, FIG. 10 illustrates an example computing device architecture 1000 of a computing device which can implement the various technologies and techniques described herein. The components of the computing device architecture 1000 are shown in electrical communication with each other using a connection 1005, such as a bus. The example computing device architecture 1000 includes a processing unit (CPU or processor) 1010 and a computing device connection 1005 that couples various computing device components including the computing device memory 1015, such as read only memory (ROM) 1020 and random access memory (RAM) 1025, to the processor 1010.

The computing device architecture 1000 can include a cache of high-speed memory connected directly with, in close proximity to, or integrated as part of the processor 1010. The computing device architecture 1000 can copy data from the memory 1015 and/or the storage device 1030 to the cache 1012 for quick access by the processor 1010. In this way, the cache can provide a performance boost that avoids processor 1010 delays while waiting for data. These and other modules can control or be configured to control the processor 1010 to perform various actions. Other computing device memory 1015 may be available for use as well. The memory 1015 can include multiple different types of memory with different performance characteristics. The processor 1010 can include any general purpose processor and a hardware or software service, such as service 1 1032, service 2 1034, and service 3 1036 stored in storage device 1030, configured to control the processor 1010 as well as a special-purpose processor where software instructions are incorporated into the processor design. The processor 1010 may be a self-contained system, containing multiple cores or processors, a bus, memory controller, cache, etc. A multi-core processor may be symmetric or asymmetric.

To enable user interaction with the computing device architecture 1000, an input device 1045 can represent any number of input mechanisms, such as a microphone for speech, a touch-sensitive screen for gesture or graphical input, keyboard, mouse, motion input, speech and so forth. An output device 1035 can also be one or more of a number of output mechanisms known to those of skill in the art, such as a display, projector, television, speaker device, etc. In some instances, multimodal computing devices can enable a user to provide multiple types of input to communicate with the computing device architecture 1000. The communications interface 1040 can generally govern and manage the user input and computing device output. There is no restriction on operating on any particular hardware arrangement and therefore the basic features here may easily be substituted for improved hardware or firmware arrangements as they are developed.

Storage device 1030 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1025, read only memory (ROM) 1020, and hybrids thereof. The storage device 1030 can include services 1032, 1034, 1036 for controlling the processor 1010. Other hardware or software modules are contemplated. The storage device 1030 can be connected to the computing device connection 1005. In one aspect, a hardware module that performs a particular function can include the software component stored in a computer-readable medium in connection with the necessary hardware components, such as the processor 1010, connection 1005, output device 1035, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

### Aspects of the Invention

Aspect 1: A method comprising: identifying a tool reference angle associated with a tool reference point that is offset from a borehole center point, wherein the tool reference angle corresponds to a rotation of a first line from a first reference plane to a borehole reference point; identifying an eccentricity angle associated with the borehole center point, wherein the eccentricity angle corresponds to a rotation of a second line from a second reference plane to the tool reference point, and the eccentricity angle is identified based on the second reference plane being parallel to the first reference plane; identifying an eccentricity magnitude based on an evaluation of a portion of a set of acquired data; calculating a borehole reference angle based on a formula that associates the borehole reference angle with values of the tool reference angle, the eccentricity angle, a borehole radius, and an eccentricity magnitude; and correcting the portion of the set of acquired data based on the formula that associates the borehole reference angle with the values of the tool reference angle, the eccentricity angle, the borehole radius, and the eccentricity magnitude.
Aspect 2: The method Aspect 1, further comprising receiving sensor data from a sensing element to include in the set of acquired data as a tool that includes the sensing element moves along a borehole.
Aspect 3: The method Aspect 1 or 2, further comprising: identifying one or more additional tool reference angles from the set of acquired data, wherein the tool reference angle and the one or more additional tool reference angles correspond to different locations of a borehole associated with the set of acquired data; identifying one or more additional eccentricity angles, wherein each respective additional tool reference angle of the one or more additional tool reference angles corresponds to a respective additional eccentricity angle of the one or more additional eccentricity angles; and correcting additional portions of the set of acquired data based on the formula.
Aspect 4: The method of any of Aspects 1 through 3, further comprising identifying a channel based on an evaluation of a corrected portion of the set of acquired data, wherein a corrective action is initiated based on the channel being identified.
Aspect 5: The method of any of Aspects 1 through 4, further comprising identifying a resolution associated with the set of acquired data, wherein the correction to the portion of the set of acquired data includes an azimuth correction and a resolution correction, wherein the azimuth correction is associated with the eccentricity magnitude, and the resolution correction is associated with the identified resolution.
Aspect 6: The method of any of Aspects 1 through 5, wherein the tool reference angle corresponds to an angle between the first line and a third line when the third line extends from the tool reference point to the borehole reference point.
Aspect 7: The method of any of Aspects 1 through 6, wherein the eccentricity angle corresponds to an angle between the second line and a fourth line, and the fourth line corresponds to a projection from the borehole center point to the tool reference point.
Aspect 8: A non-transitory computer-related storage medium having embodied thereon instructions executable by one or more processors that execute the instructions to: identify a tool reference angle associated with a tool reference point that is offset from a borehole center point, wherein the tool reference angle corresponds to a rotation of a first line from a first reference plane to a borehole reference point; identify an eccentricity angle associated with the borehole center point, wherein the eccentricity angle corresponds to a rotation of a second line from a second reference plane to the tool reference point, and the eccentricity angle is identified based on the second reference plane being parallel to the first reference plane; identify an eccentricity magnitude based on an evaluation of a portion of a set of acquired data; calculate a borehole reference angle based on a formula that associates the borehole reference angle with values of the tool reference angle, the eccentricity angle, a borehole radius, and an eccentricity magnitude; and correct the portion of the set of acquired data based on the formula that associates the borehole reference angle with the values of the tool reference angle, the eccentricity angle, the borehole radius, and the eccentricity magnitude.
Aspect 9: The non-transitory computer-related storage medium of Aspect 8, wherein the one or more processors execute instructions to organize sensor data sensed by a sensing element in the set of acquired data as a tool that includes the sensing element moves along a borehole.
Aspect 10: The non-transitory computer-related storage medium of Aspect 8 or 9, wherein the one or more processors execute instructions to: identify one or more additional tool reference angles from the set of acquired data, wherein the tool reference angle and the one or more additional tool reference angles correspond to different locations of a borehole associated with the set of acquired data; identify one or more additional eccentricity angles, wherein each respective additional tool reference angle of the one or more additional tool reference angles corresponds to a respective additional eccentricity angle of the one or more additional eccentricity angles; and correct additional portions of the set of acquired data based on the formula.
Aspect 11: The non-transitory computer-related storage medium of any of Aspects 8 through 10, wherein the one or more processors execute instructions out to identify a channel based on an evaluation of a corrected portion of the set of acquired data, wherein a corrective action is initiated based on the channel being identified.
Aspect 12: The non-transitory computer-related storage medium of any of Aspects 8 through 11, wherein the one or more processors execute instructions to: identify a resolution associated with the set of acquired data, wherein the correction to the portion of the set of acquired data includes an azimuth correction and a resolution correction, wherein the azimuth correction is associated with the eccentricity magnitude, and the resolution correction is associated with the identified resolution.
Aspect 13: The non-transitory computer-related storage medium of any of Aspects 8 through 12, wherein the tool reference angle corresponds to an angle between the first line and a third line when the third line extends from the tool reference point to the borehole reference point.
Aspect 14: The non-transitory computer-related storage medium of any of Aspects 8 through 13, wherein: the eccentricity angle corresponds to an angle between the second line and a fourth line, and the fourth line corresponds to a projection from the borehole center point to the tool reference point.
Aspect 15, an apparatus comprising: a memory; and one or more processors that executes instructions out of the memory to: identify a tool reference angle associated with a tool reference point that is offset from a borehole center point, wherein the tool reference angle corresponds to a rotation of a first line from a first reference plane to a borehole reference point; identify an eccentricity angle associated with the borehole center point, wherein the eccentricity angle corresponds to a rotation of a second line from a second reference plane to the tool reference point, and the eccentricity angle is identified based on the second reference plane being parallel to the first reference plane; identify an eccentricity magnitude based on an evaluation of a portion of a set of acquired data; calculate a borehole reference angle based on a formula that associates the borehole reference angle with values of the tool reference angle, the eccentricity angle, a borehole radius, and an eccentricity magnitude; and correct the portion of the set of acquired data based on the formula that associates the borehole reference angle with the values of the tool reference angle, the eccentricity angle, the borehole radius, and the eccentricity magnitude.
Aspect 16: The apparatus of Aspect 15, further comprising a sensor that receives sensor data to include in the set of acquired data as a tool that includes the sensor moves along a borehole.
Aspect 17: The apparatus of Aspect 15 or 16, wherein the one or more processors execute the instructions to: identify one or more additional tool reference angles from the set of acquired data, wherein the tool reference angle and the one or more additional tool reference angles correspond to different locations of a borehole associated with the set of acquired data; identify one or more additional eccentricity angles, wherein each respective additional tool reference angle of the one or more additional tool reference angles corresponds to a respective additional eccentricity angle of the one or more additional eccentricity angles; and correct additional portions of the set of acquired data based on the formula.
Aspect 18: The apparatus of any of aspects 15 through 17, wherein the one or more processors execute the instructions to identify a channel based on an evaluation of a corrected portion of the set of acquired data, wherein a corrective action is initiated based on the channel being identified.
Aspect 19: The apparatus of any of aspects 15 through 18, wherein the one or more processors execute the instructions to: identify a resolution associated with the set of acquired data, wherein the correction to the portion of the set of acquired data includes an azimuth correction and a resolution correction, wherein the azimuth correction is associated with the eccentricity magnitude, and the resolution correction is associated with the identified resolution.
Aspect 20: The apparatus of any of aspects 14 through 19, wherein the tool reference angle corresponds to an angle between the first line and a third line when the third line extends from the tool reference point to the borehole reference point.

What is claimed is:

1. A method comprising:
identifying a tool reference angle associated with a tool reference point that is offset from a borehole center point, wherein the tool reference angle corresponds to a rotation of a first line from a first reference plane to a borehole reference point;
identifying an eccentricity angle associated with the borehole center point, wherein the eccentricity angle corresponds to a rotation of a second line from a second reference plane to the tool reference point, and the eccentricity angle is identified based on the second reference plane being parallel to the first reference plane;
identifying an eccentricity magnitude based on an evaluation of a portion of a set of acquired data;
calculating a borehole reference angle based on a formula that associates the borehole reference angle with values of the tool reference angle, the eccentricity angle, a borehole radius, and an eccentricity magnitude; and
correcting the portion of the set of acquired data based on the formula that associates the borehole reference angle with the values of the tool reference angle, the eccentricity angle, the borehole radius, and the eccentricity magnitude.

2. The method of claim 1, further comprising:
receiving sensor data from a sensing element to include in the set of acquired data as a tool that includes the sensing element moves along a borehole.

3. The method of claim 1, further comprising:
identifying one or more additional tool reference angles from the set of acquired data, wherein the tool reference angle and the one or more additional tool reference angles correspond to different locations of a borehole associated with the set of acquired data;
identifying one or more additional eccentricity angles, wherein each respective additional tool reference angle of the one or more additional tool reference angles corresponds to a respective additional eccentricity angle of the one or more additional eccentricity angles; and
correcting additional portions of the set of acquired data based on the formula.

4. The method of claim 1, further comprising:
identifying a channel based on an evaluation of a corrected portion of the set of acquired data, wherein a corrective action is initiated based on the channel being identified.

5. The method of claim 1, further comprising:
identifying a resolution associated with the set of acquired data, wherein the correction to the portion of the set of acquired data includes an azimuth correction and a resolution correction, wherein the azimuth correction is associated with the eccentricity magnitude, and the resolution correction is associated with the identified resolution.

6. The method of claim 1, wherein the tool reference angle corresponds to an angle between the first line and a third line when the third line extends from the tool reference point to the borehole reference point.

7. The method of claim 1, wherein:
the eccentricity angle corresponds to an angle between the second line and a fourth line, and
the fourth line corresponds to a projection from the borehole center point to the tool reference point.

8. A non-transitory computer-related storage medium having embodied thereon instructions executable by one or more processors that implement a method comprising:
identifying a tool reference angle associated with a tool reference point that is offset from a borehole center point, wherein the tool reference angle corresponds to a rotation of a first line from a first reference plane to a borehole reference point;
identifying an eccentricity angle associated with the borehole center point, wherein the eccentricity angle corresponds to a rotation of a second line from a second reference plane to the tool reference point, and the eccentricity angle is identified based on the second reference plane being parallel to the first reference plane;
identifying an eccentricity magnitude based on an evaluation of a portion of a set of acquired data;
calculating a borehole reference angle based on a formula that associates the borehole reference angle with values of the tool reference angle, the eccentricity angle, a borehole radius, and an eccentricity magnitude; and
correcting the portion of the set of acquired data based on the formula that associates the borehole reference angle with the values of the tool reference angle, the eccentricity angle, the borehole radius, and the eccentricity magnitude.

9. The non-transitory computer-related storage medium of claim 8, wherein the one or more processors execute instructions to:
organize sensor data sensed by a sensing element in the set of acquired data as a tool that includes the sensing element moves along a borehole.

10. The non-transitory computer-related storage medium of claim 8, wherein the one or more processors execute instructions to:
identify one or more additional tool reference angles from the set of acquired data, wherein the tool reference angle and the one or more additional tool reference angles correspond to different locations of a borehole associated with the set of acquired data;
identify one or more additional eccentricity angles, wherein each respective additional tool reference angle of the one or more additional tool reference angles corresponds to a respective additional eccentricity angle of the one or more additional eccentricity angles; and
correct additional portions of the set of acquired data based on the formula.

11. The non-transitory computer-related storage medium of claim 8, wherein the one or more processors execute instructions out to identify a channel based on an evaluation of a corrected portion of the set of acquired data, wherein a corrective action is initiated based on the channel being identified.

12. The non-transitory computer-related storage medium of claim 8, wherein the one or more processors execute instructions to:
identify a resolution associated with the set of acquired data, wherein the correction to the portion of the set of acquired data includes an azimuth correction and a resolution correction, wherein the azimuth correction is associated with the eccentricity magnitude, and the resolution correction is associated with the identified resolution.

13. The non-transitory computer-related storage medium of claim 8, wherein the tool reference angle corresponds to an angle between the first line and a third line when the third line extends from the tool reference point to the borehole reference point.

14. The non-transitory computer-related storage medium of claim 8, wherein:
the eccentricity angle corresponds to an angle between the second line and a fourth line, and
the fourth line corresponds to a projection from the borehole center point to the tool reference point.

15. An apparatus comprising:
a memory; and
one or more processors that executes instructions out of the memory to:
identify a tool reference angle associated with a tool reference point that is offset from a borehole center point, wherein the tool reference angle corresponds to a rotation of a first line from a first reference plane to a borehole reference point;
identify an eccentricity angle associated with the borehole center point, wherein the eccentricity angle corresponds to a rotation of a second line from a second reference plane to the tool reference point, and the eccentricity angle is identified based on the second reference plane being parallel to the first reference plane;
identify an eccentricity magnitude based on an evaluation of a portion of a set of acquired data;
calculate a borehole reference angle based on a formula that associates the borehole reference angle with values of the tool reference angle, the eccentricity angle, a borehole radius, and an eccentricity magnitude; and
correct the portion of the set of acquired data based on the formula that associates the borehole reference angle with the values of the tool reference angle, the eccentricity angle, the borehole radius, and the eccentricity magnitude.

16. The apparatus of claim 15, further comprising:
a sensor that receives sensor data to include in the set of acquired data as a tool that includes the sensor moves along a borehole.

17. The apparatus of claim 15, wherein the one or more processors execute the instructions to:
identify one or more additional tool reference angles from the set of acquired data, wherein the tool reference angle and the one or more additional tool reference angles correspond to different locations of a borehole associated with the set of acquired data;
identify one or more additional eccentricity angles, wherein each respective additional tool reference angle of the one or more additional tool reference angles corresponds to a respective additional eccentricity angle of the one or more additional eccentricity angles; and
correct additional portions of the set of acquired data based on the formula.

18. The apparatus of claim 15, wherein the one or more processors execute the instructions to:
identify a channel based on an evaluation of a corrected portion of the set of acquired data, wherein a corrective action is initiated based on the channel being identified.

19. The apparatus of claim 15, wherein the one or more processors execute the instructions to:
identify a resolution associated with the set of acquired data, wherein the correction to the portion of the set of acquired data includes an azimuth correction and a resolution correction, wherein the azimuth correction is associated with the eccentricity magnitude, and the resolution correction is associated with the identified resolution.

20. The apparatus of claim 15, wherein the tool reference angle corresponds to an angle between the first line and a third line when the third line extends from the tool reference point to the borehole reference point.
